(19) United States
(12) Patent Application Publication
(10) Pub. No.: US 2009/0021524 A1
(43) Pub. Date: Jan. 22, 2009

(54) Color Selection System and Method

(76) Inventors: JoAnne Lenart-Weary, Waterford, PA (US); Cynthia Stefanik, Erie, PA (US)

Correspondence Address: EDWARD W. GOEBEL, JR.;MACDONALD, ILLIG, JONES & BRITTON LLP, 100 STATE STREET, SUITE 700, ERIE, PA, 16507-1498, US

(21) Appl. No.: 12/175,928

(22) Filed: Jul. 18, 2008

Related U.S. Application Data
(60) Provisional application No. 60/950,457, filed on Jul. 18, 2007.
(60) Provisional application No. 61/013,729, filed on Dec. 14, 2007.

(51) Int. Cl. G09G 5/02

(52) U.S. Cl. 345/593

(57) ABSTRACT

A system and method for sorting and selecting colors from a palette of colors are provided. A color identification standard representing the color spectrum is selected. The color identification standard comprises color groups from which color harmonies can be created. The colors are sorted by a first attribute of the color. For each first attribute level, the colors are further sorted to correspond to the color groups in the selected color identification standard. Each color is further sorted within its color group into a gradient of colors based on the amount of color from adjacent color groups that is present in each color and the number of colors in the color group. In a color palette so sorted, for each color corresponding available harmonious colors are generally sorted to about the same relative location within their respective color groups. The colors are further sorted by a second attribute of the color.

This application takes priority from U.S. provisional application 60/950,457 filed Jul. 18, 2007 and provisional application 61/013,729 filed Dec. 14, 2007.

### BACKGROUND

Color, or hue, more often than not, drives purchasing decisions. Whether for coordinating clothing, decorating a home, purchasing a new car or deciding which music player to buy, color is what makes one product appear different from another. In some cases, color is simply a favorite choice that is not meant to harmonize with anything, such as the color of a toothbrush. In other cases, selecting the wrong color can be a very expensive mistake. Whether it is shoes, sofas, or paints, color and color harmonies are something most people struggle with.

Decorating professionals often apply their own personal taste in colors to a home without successfully identifying the preferences of the customer. A result is that the customer adapts to the decorator's style instead of the decorator creating a beautiful room that adapts to the customer's personal style. Color choice becomes subjective to the decorator.

While color theory can objectively identify harmonious colors, there has not been an easy way to apply color theory to determine the best harmonious matches for a wide selection of colors. Possibly for this reason, manufacturers are often unaware, unable, or unwilling to develop their product lines to conform to basic color theory. The term color palette will be used to describe all of the colors available for a particular purpose. For example, a color palette includes all of the hues of paint available for a particular purpose, the range of colors of fabrics available for a particular purpose, the colors of building materials available for a particular project, etc.

### SUMMARY

A system and method for sorting and selecting colors from a palette of colors are provided. A color identification standard representing the color spectrum is selected. The color identification standard comprises color groups from which color harmonies can be created. The colors are sorted by a first attribute of the color. For each first attribute level, the colors are further sorted to correspond to the color groups in the selected color identification standard. Each color is further sorted within its color group into a gradient of colors based on the amount of color from adjacent color groups that is present in each color and the number of colors in the color group. In a color palette so sorted, for each color corresponding available harmonious colors are generally sorted to about the same relative location within their respective color groups. The colors are further sorted by a second attribute of the color.

For a selected first color from the sorted palette of colors and a desired type of harmonious color combination with respect to the first color, the color selection system and method enables relatively easy identification of harmonious color groups. The sorted color palette allows for identification of the color group of the first color, identification of color groups that are harmonious with the first color based on the desired type of harmonious color combination, and selection of a color within each identified color group at about the same relative location in the identified color group that the first color is in its color group to create an appropriate harmonious color combination with the first color.

In some embodiments, the first attribute of the color is saturation and the second attribute of the color is value. In other embodiments, the first attribute of the color is value and the second attribute of the color is saturation. The systems and methods apply to any color palette for fabrics, paints, inks, stains, dyes, or any other medium used to alter a color.

The systems and methods can also be applied to computerized color selection systems that include computerized databases that store the sorted and identified colors in the palette of colors. In some embodiments, the computerized database can include categories of various types of harmonious color combinations. In some embodiments, for each color and for each type of harmonious color combination, the computerized database can include identified appropriate harmonious color combinations in the palette of colors. In other embodiments, for a selected first color from the computerized database and a selected type of harmonious color combination, the computerized color selection system identifies the color group of the first color, the color groups that are harmonious with the first color based on the selected type of harmonious color combination, and identifies a color within each identified color group that is closest to the relative location in the identified color group that the first color is in its color group to create an appropriate harmonious color combination with the first color.

The computerized databases can also include wavelength information for each color. In some embodiment of systems, a spectrograph is connectable to the computerized color selection system, such that the wavelength of a sample of color outside of the palette of colors can be measured and matched to the color having the closest similar wavelength in the palette of colors.

Those skilled in the art will realize that this invention is capable of embodiments different from those shown and described herein and that details of the devices and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 is a color identification standard that is a circle divided into twelve color groups;

FIG. 2 is a color identification standard that is a circle divided into six color groups;

FIG. 3 is a color identification standard that is a triangle showing twelve color groups;

FIG. 4 is a linear color identification standard divided into twelve color groups;

FIG. 5 is the color identification standard of FIG. 1 showing two examples of complementary color harmonies;

FIG. 6 is the color identification standard of FIG. 1 showing an example of a split complementary color harmony;

FIG. 7 is the color identification standard of FIG. 1 showing an example of a triadic color harmony in which the harmonious colors are equidistant from each other;

FIG. 8 is the color identification standard of FIG. 1 showing an example of a tetradic color harmony with pairs of complementary colors;

FIG. 9 is the color identification standard of FIG. 1 showing an example of a tetradic color harmony with a different pair of complementary colors;

FIG. 10 is the color identification standard of FIG. 1 showing an example of a tetradic color harmony with a different pair of complementary colors with each color separated by two color groups;

FIG. 11 is the color identification standard of FIG. 1 showing an example of an analogous color harmony;

FIG. 12 is the color identification standard of FIG. 1 showing an example of an asymmetric color harmony;

FIG. 13 is the color identification standard of FIG. 3 showing two examples of complementary color harmonies;

FIG. 14 is the color identification standard of FIG. 3 showing an example of a split complementary color harmony;

FIG. 15 is the color identification standard of FIG. 3 showing an example of a triadic color harmony in which the harmonious colors are equidistant from each other;

FIG. 16 is the color identification standard of FIG. 3 showing an example of a tetradic color harmony with pairs of complementary colors;

FIG. 17 is the color identification standard of FIG. 3 showing an example of a tetradic color harmony with a different pair of complementary colors;

FIG. 18 is the color identification standard of FIG. 3 showing an example of a tetradic color harmony with a different pair of complementary colors with each color separated by two color groups;

FIG. 19 is the color identification standard of FIG. 3 showing an example of an analogous color harmony;

FIG. 20 is the color identification standard of FIG. 3 showing an example of an asymmetric color harmony;

FIG. 21 is the color identification standard of FIG. 4 showing two examples of complementary color harmonies;

FIG. 22 is the color identification standard of FIG. 4 showing an example of a split complementary color harmony;

FIG. 23 is the color identification standard of FIG. 4 showing an example of a triadic color harmony in which the harmonious colors are equidistant from each other;

FIG. 24 is the color identification standard of FIG. 4 showing an example of a tetradic color harmony with pairs of complementary colors;

FIG. 25 is the color identification standard of FIG. 4 showing an example of a tetradic color harmony with a different pair of complementary colors;

FIG. 26 is the color identification standard of FIG. 4 showing an example of a tetradic color harmony with a different pair of complementary colors with each color separated by two color groups;

FIG. 27 is the color identification standard of FIG. 4 showing an example of an analogous color harmony;

FIG. 28 is the color identification standard of FIG. 4 showing an example of an asymmetric color harmony;

FIG. 29 shows six color strips showing colors at one saturation level along with a range of values for each color;

FIG. 30 shows some of the colors at the bright saturation level from a color palette that has been sorted by saturation level into the color identification standard shown in FIG. 1;

FIG. 31 shows some of the colors at the bright saturation level from a color palette that has been sorted by saturation level into the color identification standard shown in FIG. 3;

FIG. 32 shows some of the colors at the bright saturation level from a color palette that has been sorted by saturation level into the color identification standard shown in FIG. 4;

FIG. 33 shows six color strips showing colors at one value along with a range of saturation levels for each color;

FIG. 34 shows some of the colors at a value of 10 from a color palette that has been sorted by value into the color identification standard shown in FIG. 1;

FIG. 35 shows some of the colors at a value of 10 from a color palette that has been sorted by value into the color identification standard shown in FIG. 3;

FIG. 36 shows some of the colors at a value of 10 from a color palette that has been sorted by value into the color identification standard shown in FIG. 4;

FIG. 37 shows a color identification standard for a color palette having five colors in each color group at a single saturation level;

FIG. 38A shows the upper left quarter of a color identification standard for a color palette having an irregular number of colors in each color group at a single saturation level;

FIG. 38B shows the upper right quarter of the color identification standard of FIG. 38A for a color palette having an irregular number of colors in each color group at a single saturation level;

FIG. 38C shows the lower left quarter of the color identification standard of FIG. 38A for a color palette having an irregular number of colors in each color group at a single saturation level;

FIG. 38D shows the lower right quarter of the color identification standard of FIG. 38A for a color palette having an irregular number of colors in each color group at a single saturation level; and

FIG. 39 is a flow chart showing the steps for color selection using a color selection computer program incorporating the color selection system described herein.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

### Color Identification Standards

Color is the visual spectrum of light reflected off objects that humans can perceive. The colors of the visible light spectrum can be arranged on a variety of color identification standards to show the gradual change of colors across the spectrum. These color identification standards often categorize the color spectrum into color groups with generally identifiable labels such as red, yellow, blue, etc. Each color group is defined for convenience as the color with which it is identified. In reality, each color group comprises a gradient of colors that constitute a mixture of the named color with a minor percentage of colors from the color groups adjacent to it.

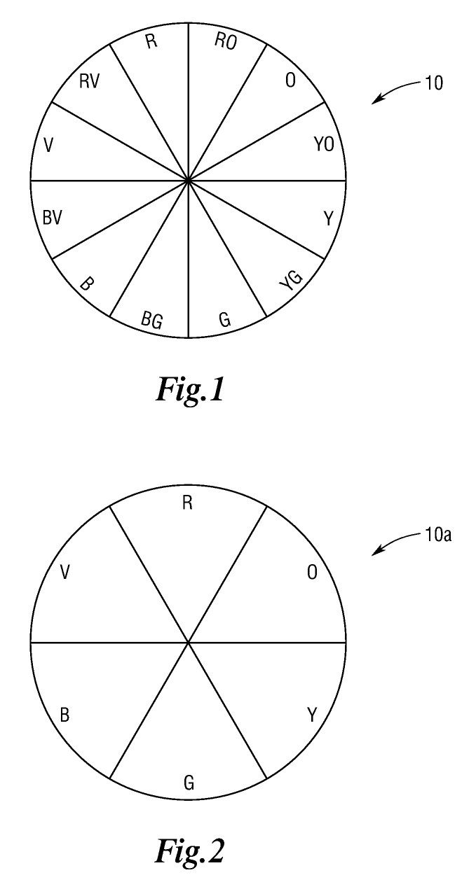

The size of each color group in particular color identification standards is inconsequential so long as each color group is consistently delineated. For example, the color identification standard 10 shown in FIG. 1 is a circle that identifies twelve color groups of equal dimensions titled sequentially as: red, red-orange, orange, yellow-orange, yellow, yellow-green, green, blue-green, blue, blue-violet, violet, and red-violet. The identification standard 10 functions just as well if the color groups were labeled sequentially with the alphabets A through L or numbered sequentially 1 through 12. For the purposes of this discussion, the color groups in FIG. 1 are labeled R, RO, O, YO, Y, YG, G, BG, B, BV, V, and RV—abbreviations for the names of the color groups listed above.

The number of color groups is similarly arbitrary. For example, a color identification standard 10a can have six color groups in a circle as shown in FIG. 2. In this example, the color groups are labeled R, O, Y, G, B, and V, as abbreviations for red, orange, yellow, green, blue, and violet. Available color identification standards also include circles having other numbers of color groups. Color identification standards can also utilize other geometric shapes such as triangles, rectangles, squares, three-dimensional spheres, or any other shape in which color groups of equal size and dimension can be identified.

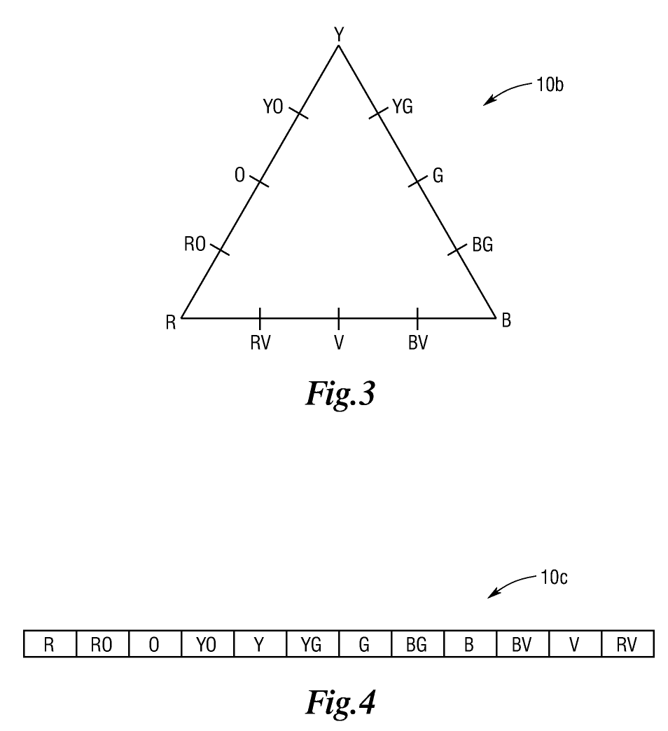

The triangular color identification standard 10b shown in FIG. 3 has twelve color groups of equal dimensions and are identified sequentially as: red, red-orange, orange, yellow-orange, yellow, yellow-green, green, blue-green, blue, blue-violet, violet, and red-violet. As with the earlier examples, for the purposes of discussion, the color groups in FIG. 3 are labeled R, RO, O, YO, Y, YG, G, BG, B, BV, V, and RV on the outer edge of the triangle 10b—abbreviations for the names of the color groups. These identify the points on the triangle 10b that correspond to 100% of the identified color. The perimeter of the triangle 10b is a continuous transition of one color to the next in varying proportion of adjacent colors.

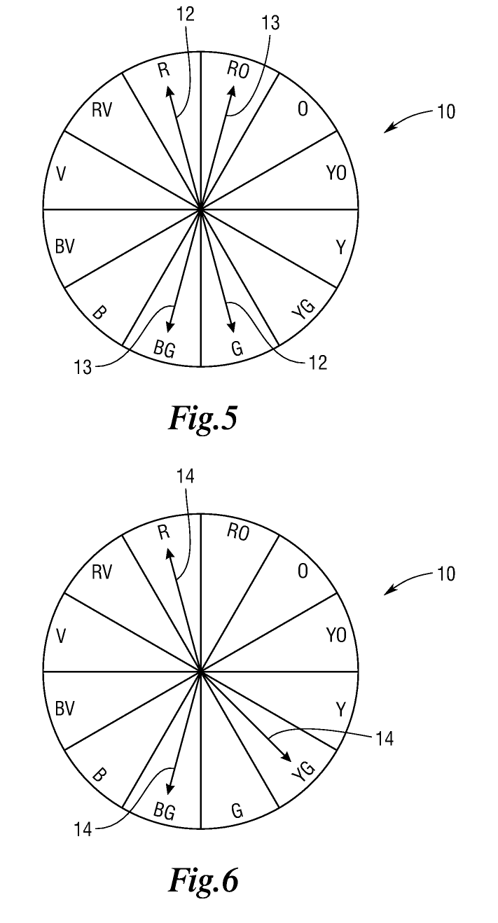

FIG. 4 shows a linear color identification system 10c in which the color groups are arranged along the length. The linear color identification system 10c can be a line if no additional information is presented or a rectangle as shown. As with the earlier examples, for the purposes of discussion, the color groups in FIG. 4 are labeled R, RO, O, YO, Y, YG, G, BG, B, BV, V, and RV and show a continuous transition of the color spectrum from one color to the next.

### Saturation Level and Value

Beyond classifying the color by the color group, colors have other identifiable attributes: saturation level and value. The saturation level of a color is how pure the color is as compared to black. The more saturated a color is, the more pure, bright, or strong that it is versus a less saturated version of the same color which is duller, more subdued, or neutral. The more saturated a color is, the “cooler” and “brighter” it is. A less saturated color is “warmer” and more “neutral” than a cool saturated color. Adding any, or a combination of, black, brown, grey, and/or the color's complement to a color alters the color's saturation. For example, if a small amount of black, brown, grey, or, its complement, green is added to red, the result is a more subdued, warmer and less saturated version of the red.

Value is the extent of the presence or addition of white to a particular color—the more white in a color, the lighter it appears. Mixing the color with white changes the value of a color. Lighter colors are considered to have higher values while deep and darker colors are considered to have lower values. This provides a range of the color from pastels all the way to deep and dark versions of the color. Since a color mixed with white is essentially the same color, a color is often presented with a range of color values.

Colors of various saturation levels or values can be included in color identification standards. For example, in circular color identification standards 10 and 10a in FIGS. 1 and 2 each color could be arranged such that various values or various saturation levels for each color are presented from the circumference of the circles to the center. Similarly, in the triangular color identification standard 10b of FIG. 3, the colors extending from the perimeter of the triangle to the center may be the colors at various values or various saturation levels. In the linear color identification system 10c of FIG. 4, while the color groups are arranged along the length, increasing values or saturations of each color can be presented along the width.

### Color Harmonies

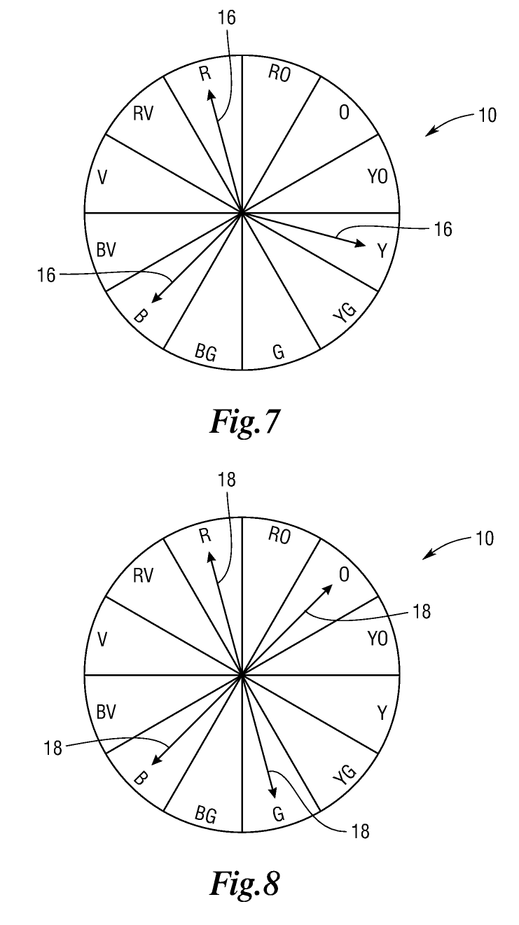

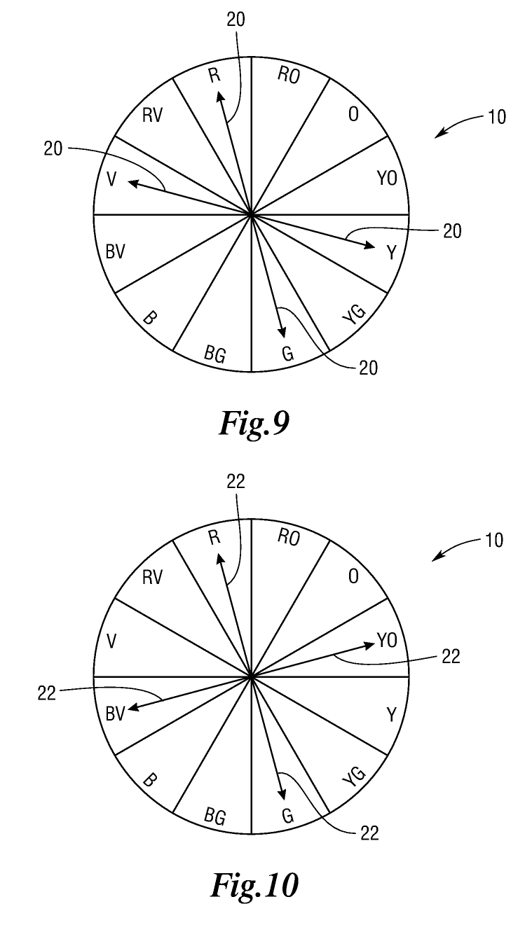

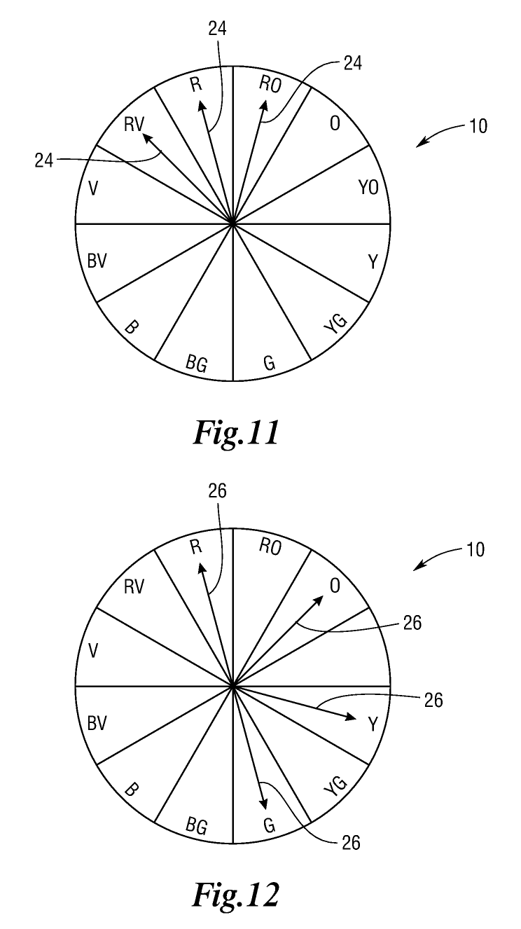

According to color theory, there are several combinations of colors considered to be harmonious. Harmonious color combinations can be shown, for purposes of illustration, using the circular color identification standard 10 in FIG. 1. Colors directly opposite each other on the color identification standard 10 are complementary to each other. As illustrated in FIG. 5, the arrows 12 show that R is complementary to G, and the arrows 13 show that RO is complementary to BG, etc. A split complementary relationship is a color with the two colors that flank its complementary color. In FIG. 6 the arrows 14 show an example of a split complementary relationship between R, YG, and BG. Another color harmony with three colors is a triadic harmony in which each color is equidistant on the identification standard 10. In FIG. 7 the arrows 16 show an example of a triadic harmonious relationship between R, B, and Y. Two pairs of complementary colors create a tetrad color harmony. In FIG. 8 the arrows 18 show an example of a tetradic harmonious relationship between R, O, G, and B. In FIG. 9 the arrows 20 show an example of a tetradic harmonious relationship between R, G, V, and Y. Four colors evenly spaced from one another on the identification standard 10 also create tetradic color harmonies. In FIG. 10 the arrows 22 show an example of a tetradic harmonious relationship between R, BV, G, and YO. Selecting colors from three to five adjacent color groups creates an analogous color harmony. In FIG. 11 the arrows 24 show an example of an analogous harmonious relationship between three colors RV, R, and RO. An asymmetric color harmony is a selection of colors using only one half of the colors on an identification standard 10 . In FIG. 12 the arrows 26 show an example of an asymmetric color harmony with R, O, Y, and G.

Monochromatic harmonies can also be identified within a single color group. Different values of the same color result in various tints that create monochromatic harmonies. Similarly, different saturation levels of a single color create various tones (the color plus grey or brown in various degrees), and shades (the color plus black in various degrees), for monochromatic harmonies. In every case harmonious colors to a selected color are at approximately the same location within their color group as the selected color is in its color group. Therefore given a selected color and its known harmonious color combinations, if a different color is selected that is a known distance to the left or right of the selected color, the harmonious colors combinations to the new color choice are equally to the left or right in their respective color group.

Because a circular color identification system has no beginning or end, a circle as shown in FIGS. 1 and 2 is the easiest way to accommodate the color spectrum and show the color harmonies for various color choices. However, as mentioned above, any shape can be adapted to the color selection system disclosed herein so long as each defined color group is arranged according to the natural spectrum and each color group is equally sized. In every case, harmonious color combinations to a selected color are located at approximately the same location in their respective color groups as the selected color is in its color group. For the purposes of this discussion the harmonious relationships are discussed for color identification standards having twelve color groups as above, but such relationships are easily identified in color identification standards with differing numbers of color groups.

Complementary colors are a pair of colors such that the distance between each color is the same in every direction along the color identification standard. In color identification standards with twelve color groups, complementary colors are two colors that are six color groups apart. A split complementary relationship is a color and two colors in color groups on either side of the color's complement. A triadic relationship is three equidistant colors—in color identification standards with twelve color groups, each color is four color groups apart. Tetrad relationships are harmonious relationships between two pairs of complementary colors. There are two kinds of tetrad relationships: two pairs of complementary colors two color groups apart; and two pairs of complementary colors four color groups apart with each color equidistant to the next color. In color identification standards with twelve colors, an asymmetrical relationship is a group of up to four colors that are one color group apart. An analogous relationship is three colors sharing a common letter—for example analogous color can be selected from RO, R, and RV or BV, V, and RV. A monochromatic relationship is one color selected at different tints, tones, and shades depending on the saturation level and value.

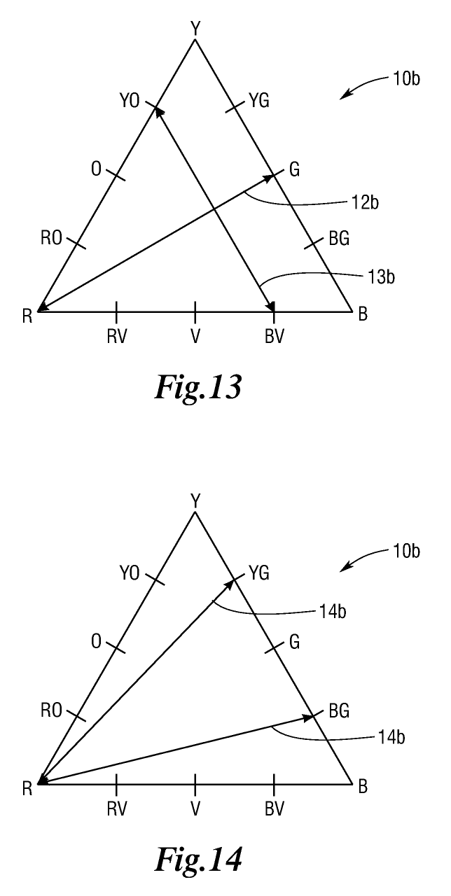

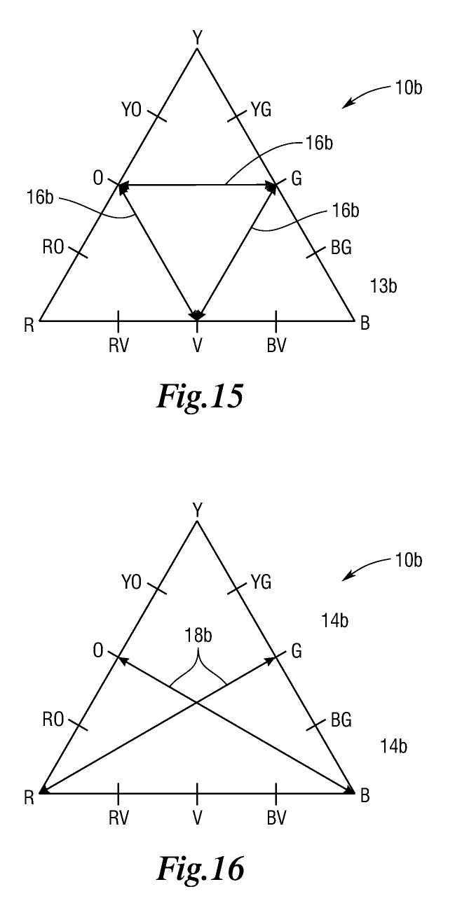

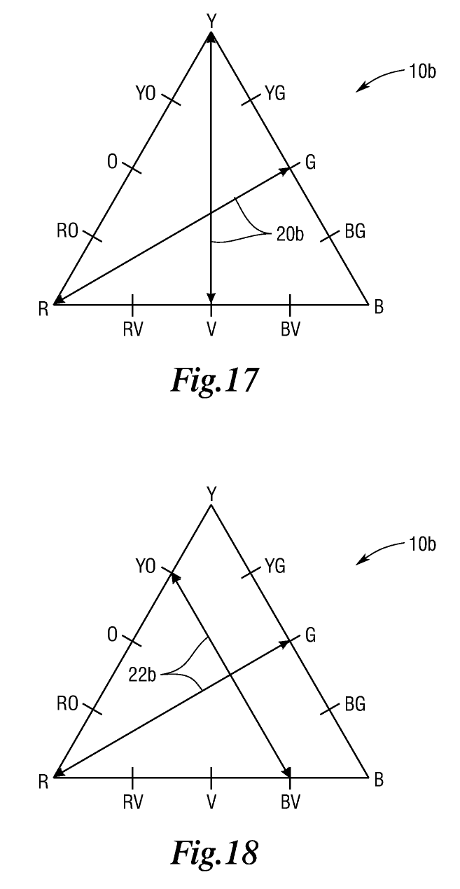

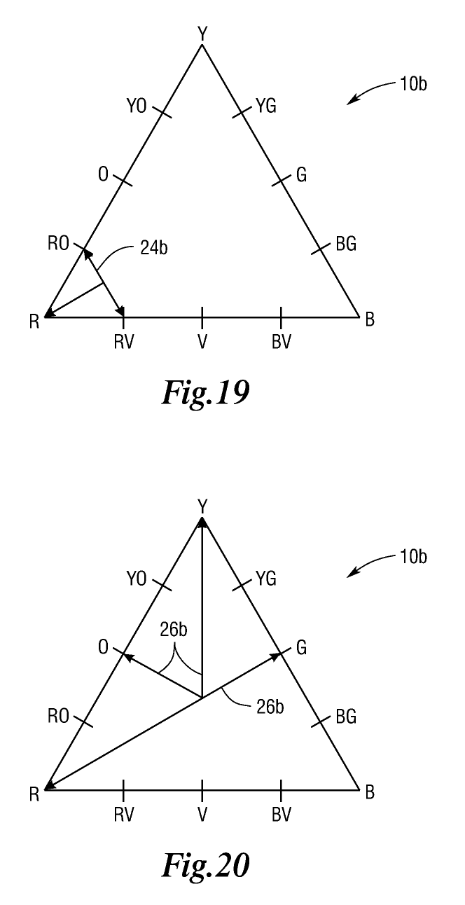

Applying these principles to the triangular color selection system 10b in FIG. 13 the arrows 12b show R and its complement G, and the arrows 13b show YO and its complement BV. In FIG. 14 the arrows 14b show an example of a split complementary relationship between R, YG, and BG. In FIG. 15 the arrows 16b show an example of a triadic harmonious relationship between O, G, and V. In FIG. 16 the arrows 18b show an example of a tetradic harmonious relationship between R, O, G, and B. In FIG. 17 the arrows 20b show an example of a tetradic harmonious relationship between R, G, V, and Y. In FIG. 18 the arrows 22b show an example of a tetradic harmonious relationship between R, BV, G, and YO. In FIG. 19 the arrows 24b show an example of an analogous harmonious relationship between three colors RV, R, and RO. In FIG. 20 the arrows 26b show an example of an asymmetric color harmony with R, O, Y, and G.

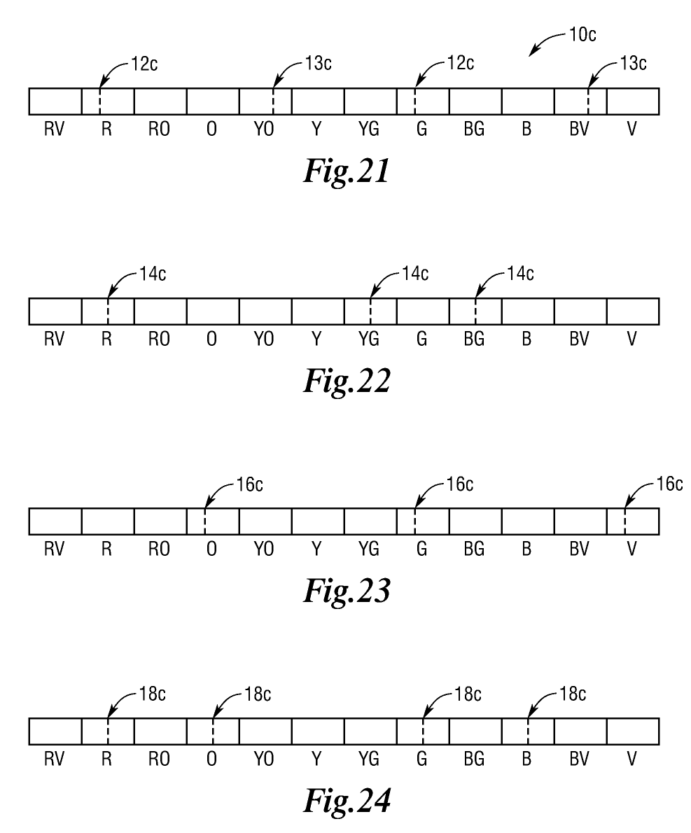

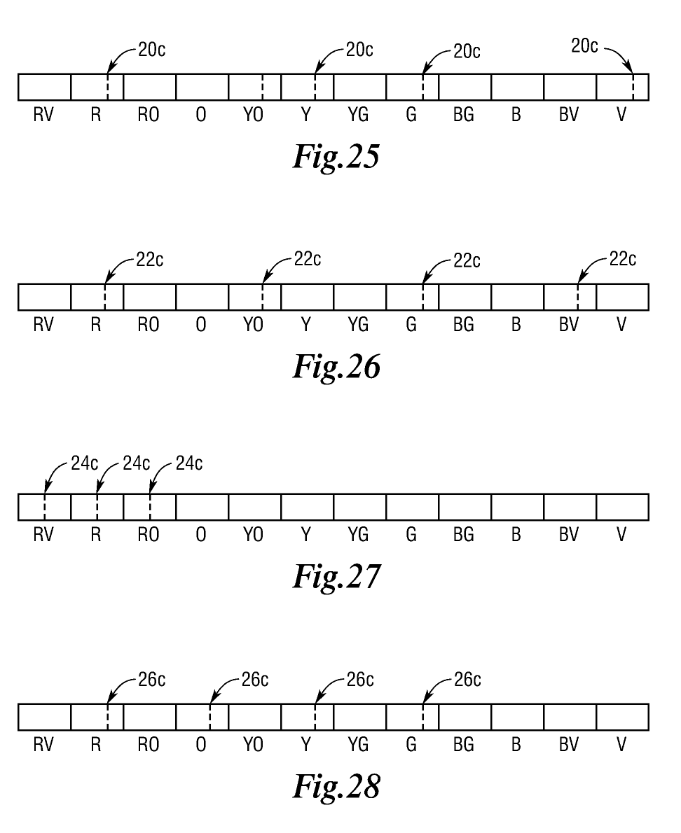

Applying the same color harmony principles to color selection systems of other geometries is also possible. FIG. 21 shows a linear color identification system 10c in which the arrows 12c show R and its complement G, and the arrows 13c show YO and its complement BV. In FIG. 22 the arrows 14c show an example of a split complementary relationship between R, YG, and BG. In FIG. 23 the arrows 16c show an example of a triadic harmonious relationship between O, G, and V. In FIG. 24 the arrows 18c show an example of a tetradic harmonious relationship between R, O, G, and B. In FIG. 25 the arrows 20c show an example of a tetradic harmonious relationship between R, G, V, and Y. In FIG. 26 the arrows 22c show an example of a tetradic harmonious relationship between R, BV, G, and YO. In FIG. 27 the arrows 24c show an example of an analogous harmonious relationship between three colors RV, R, and RO. In FIG. 28 the arrows 26c show an example of an asymmetric color harmony with R, O, Y, and G.

These color harmonies are applicable anywhere color choice is needed—whether in choosing paints for rooms, selecting fabrics for furniture, selecting matching clothing, matching the interior colors of a car to its exterior colors, matching the color of a roof to the color of the rest of the building, etc. The color harmonies apply to paints, fabrics, inks, stains, dyes, or any other medium used to alter a color. While all of these various harmonies are known, properly applying them to a given color palette is difficult and is often subjective to the decorator. Picking these harmonies is not merely a matter of knowing which color groups are harmonious, but also knowing where within each of the color groups of the color identification standard 10 the particular color chosen and its various harmonies actually lie.

Since each color group is in reality a gradient of colors from and to adjacent color groups, a color that is at one end of a color group will appear very similar to a nearby color in the adjacent color group. For example, in any of the color identification standards shown above 10, 10b, or 10c in FIGS. 1, 3, and 4, a color in the far left of the R color group will look very similar to a color in the far right of the RV group. The only way to be certain into which color group a particular color falls is for the manufacturer of the color to identify where on a selected color identification standard the color actually lies. Otherwise, any color harmony selection is subjective to the decorator and cannot be assured to be the most harmonious selection available. Nevertheless, given a color palette, it is possible to arrange the colors in such a way that the color harmonies can be quickly determined. A properly arranged color palette enables the selection of color harmonies within the limits of the color palette without the need to look at the selected colors side by side. Saturation levels are a better indicator of color harmony than the subjective impression of a “favorite color”.

### Sorting a Color Palette by Saturation Level

First, select an appropriate color identification standard representing the color spectrum comprising color groups from which color harmonies can be created. While the method disclosed herein is applicable to any color identification standard from which equally sized color groups can be identified, for purposes of illustration, refer to the color identification standard 10 that comprises a twelve-color group circle shown in FIG. 1. The colors in the color palette are then sorted or labeled according to their saturation level. If the manufacturer of the colors in the color palette has properly identified the saturation levels of each color, then sorting and labeling each color by saturation level is straightforward. If not, then the colors are labeled or grouped by comparing each color and identifying relative saturation levels.

For each saturation level, each color is then sorted and/or labeled into one of the color groups to correspond to the order established by the selected color identification standard. Each color is further labeled and/or sorted within each color group into a gradient of colors based on the amount of color from one of the two adjacent color groups that is present in that color. The color is further labeled according to the number of colors in its color group and its location in the sequence of colors in its color group. For example in a color palette sorted according to the color identification standard 10 of FIG. 1, given a color to be labeled that falls in the orange color group, its labeling sequence is as follows: It is first labeled according to its saturation, then with its color—orange in this case, then according to the number of colors in its color group and the amount of color in it from adjacent color groups—red-orange and yellow orange in this case. If the color has the most amount of red compared to the other colors in the orange group, then it is labeled 1/10.

The transition from one color to the next in each color group and from the end color in one color group to the adjacent end color in an adjacent color group is subtle. Each color is incrementally different from its adjacent colors in the selected color identification standard. For example, if the color palette had five colors that fit in the red color group, the first color in the gradient that is adjacent to the red-violet color group has more red-violet characteristics than the second color in the red color group, and so on. The last color in the red color group that is adjacent to the red-orange color group has the most red-orange characteristics of the colors in the red color group.

Knowledge of the actual composition of the colors in any particular palette removes any uncertainty as to which color group a particular color belongs. For example, in a color identification standard having twelve color groups, if the color were composed of 75% or more red, then it will be classified in the red color group. If it were between 25% and 75% red and the remainder violet, it will be classified in the red-violet color group, etc.

Nevertheless, what is most important is that the colors are placed in each color group of each saturation level with the same criteria across the color palette. The colors are sorted and/or labeled according to their position in the color group. The number of colors in each color group is also noted and/or labeled onto each color as well.

Colors are also often presented in color palettes with different values—i.e. the color with different levels of white mixed in. Variations in value across harmonious color combinations have less impact on a harmony than variations in saturation and, as discussed below, different color values provide additional color harmony choices. If the colors of the color palette are so presented with various color values, then the colors should each be further labeled and/or sorted to identify the color's value.

Each of the color palette's saturation levels can be labeled numerically, alphabetically, as a percentage of color saturation, by the conventional saturation labels (bright, cool, warm, neutral, etc.), or by any other convention. The color groups within each saturation level can be labeled according to the selected color identification standard being used, such as the color identification standards 10, 10a, 10b, or 10c shown in FIGS. 1 through 4, or they can be labeled numerically, alphabetically, or by any other convention. Within each of the color groups, the colors can be labeled numerically, alphabetically, or by any other convention that is consistent across all the color groups. The color value of each color can also be labeled numerically, alphabetically, or by any other convention that is consistent across all the colors.

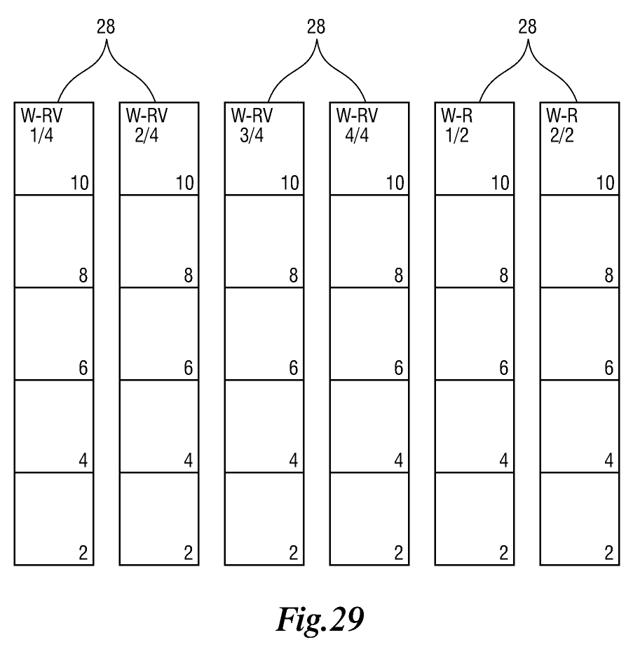

For example, as shown in FIG. 29, household paint color palettes are often presented in color strips 28. Each color strip 28 shows a color at a particular saturation. The same color is also presented at different values along each color strip 28, i.e. the same color shown at a range of lightness. In FIG. 29, five value levels are shown in ascending order of value for each color strip 28. Each value level can be labeled as a proportion of each color to white. I.e., a value of 10 is the pure color; a value of 8 would be a mixture comprising 80% of the pure color and 20% white, etc. A color palette comprises a collection of such color strips 28 compiled to show the range of available colors. Manufacturers often provide additional information on these color strips 28, such as the marketing name of the paint, the saturation level of the color, etc. The example shown in FIG. 29 assumes a color palette having a saturation level labeled “warm,” and includes four colors in the warm red-violet color group and two colors in the warm red color group applied to an appropriate color identification system. The six colors are labeled as follows: W-RV 1/4, W-RV 2/4, W-RV 3/4, and W-RV 4/4 within the warm red-violet color group and W-R 1/2 and W-R 2/2 in the warm red color group. The remainder of the color palette is similarly labeled for the “warm” saturation level and for each other saturation level.

It becomes relatively easy to identify harmonious color combinations for a color palette so sorted. For example, assume a sorted and/or labeled color palette with four saturation levels. The color palette is sorted and/or labeled according to conventional saturation labels (Bright, Cool, Warm, Neutral). The colors in the color palette are further sorted and/or labeled in accordance with the twelve color groups in the color identification system 10, 10b, or 10c shown in FIGS. 1, 3, and 4 with each color sorted and/or labeled numerically in each color group. Assume also that the color palette has at least one color in each color group at each saturation level. If a harmonious color combination is desired for a given color, say a bright saturated red, the color, or a color that's closest to it, must first be located within the sorted and/or labeled color palette.

The first step is to determine the saturation level of the given color in relation to the color palette. If the given color appears to most closely match the most saturated colors in the color palette, the bright colors of the color palette are selected and the remainder put aside. Note that with this one step, 75% of the colors in the color palette have been eliminated from consideration as not being likely to provide harmonious color combinations.

The color group that the given color most resembles is then identified. If the red of the given color appears to have neither substantial red-orange nor substantial red-violet characteristics, it is likely that the closest color in the color palette is at or about the center of the color gradient of the R (red) color group. Harmonious color combinations based on known color harmonies can then be identified.

### EXAMPLE 1

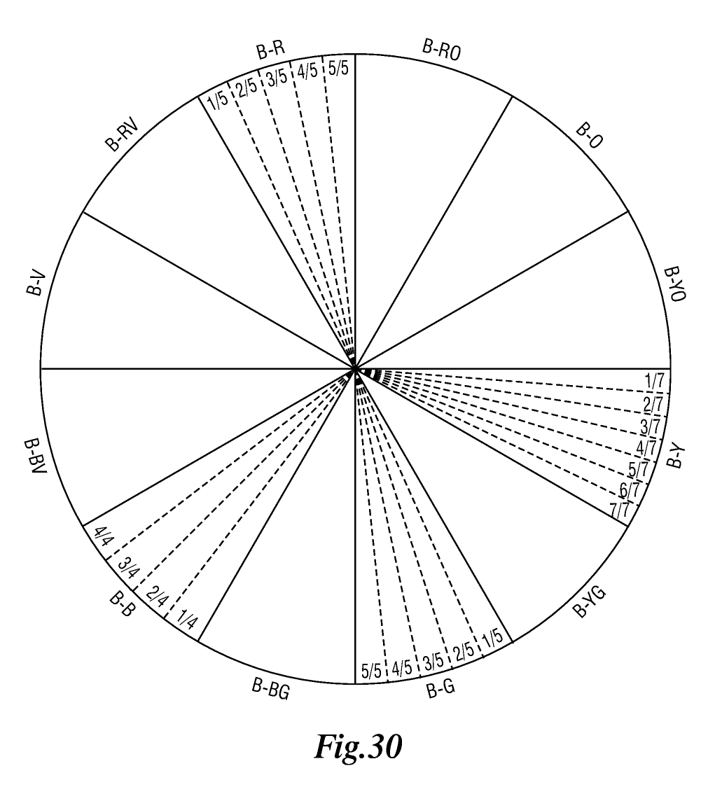

Referring now to FIGS. 30 through 32, if there were five colors in the R (red) color group of the bright saturation level, they would be labeled B-R 1/5, B-R 2/5, B-R 3/5, B-R 4/5, and B-R 5/5. The closest color to the red color indicated above is the third of the five colors at the center of the B-R color group. According to the example color palette, that color is labeled B-R 3/5. With the color now identified, harmonious relationships can be developed based on known color harmonies. The complementary color to B-R 3/5 is located at about the center of the color gradient green (G) color group at the same saturation level (B or bright). If there are five colors in the bright (B) green (G) color group, they would be labeled B-G 1/5, B-G 2/5, B-G 3/5, B-G 4/5, and B-G 5/5. The complementary color to the B-R 3/5 at the center of the bright (B) green (G) color group is B-G 3/5.

Similarly, the harmonious color group representing the split complementary colors to B-R 3/5 is at about the center of the gradient of colors in the B (blue) and Y (yellow) color groups at the B (bright) saturation level. If the B group has four colors, they are labeled B-B 1/4, B-B 2/4, B-B 3/4, and B-B 4/4. If the Y group has 7 colors, they are labeled B-Y 1/7, B-Y 2/7, B-Y 3/7, B-Y 4/7, B-Y 5/7, B-Y 6/7, and B-Y 7/7. Because the B color group has an even number of colors, both B-B 2/4 and B-B 3/4 are at about the center of the color group. Therefore two split complementary harmonious relations are possible: B-R 3/5, B-B 2/4, and B-Y 4/7; and B-R 3/5, B-B 3/4, and B-Y 4/7. Other harmonious relationships are similarly identified by applying the same technique to the known color theory harmonies similar to the examples shown in FIGS. 5 through 28 or other known color harmonies.

### EXAMPLE 2

If the number of colors in the harmonious color group is not equal to the number of colors in the selected color group, then the best available harmonious color is one whose location in the harmonious color group most closely corresponds to the location of the selected color in it's color group. Therefore referring to Example 1, if there were eight colors in the bright green color group, they would be labeled B-G 1/8, B-G 2/8, B-G 3/8, B-G 4/8, B-G 5/8, B-G 6/8, B-G 7/8, and B-G 8/8. The most harmonious color to B-R 3/5 is located at about the center of the gradient of colors in the green color group. Given that there are eight colors in the G color group, the complementary colors are either B-G 4/8 or B-G 5/8.

### EXAMPLE 3

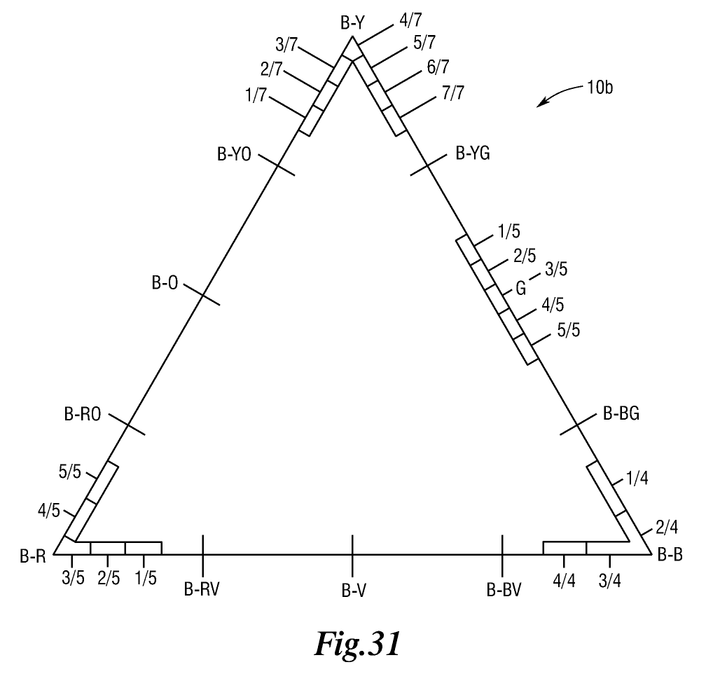

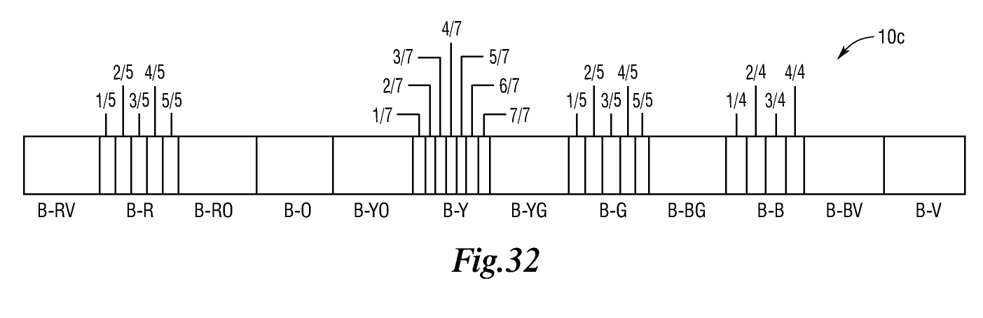

In example 1, if it were determined that a slightly different color in the R color group was a better choice, new color harmonies are determined by applying the technique described above. Harmonious color combinations are located within their respective color groups based on the position of the new color within the B-R color group. Referring again to FIGS. 30 through 31, if the selected color were changed to B-R 2/5, one color choice in the counterclockwise direction in the selected color group, the most appropriate color harmonies will correspondingly change by one color choice in the counterclockwise direction in the harmonious color groups. Similarly, referring to FIG. 32, if the selected color were changed to B-R 2/5, one color choice to the left in the selected color group, the most appropriate color harmonies will correspondingly change by one color choice to the left in the harmonious color groups. Thus, if there are five colors in the B-G color group, the complementary color is now B-G 2/5. If there are four colors in the B-B color group and seven in the B-Y color group then there are a few more options for the split complementary harmonies. Possible split complementary relations are: B-R 2/5, B-B 1/4, and B-Y 3/7; B-R 2/5, B-B 2/4, and B-Y 3/7; B-R 2/5, B-B 1/4, and B-Y 2/7; and B-R 2/5, B-B 2/4, and B-Y 2/7.

If the colors in the color palette in the above examples are provided with a gradient of values, i.e. mixed with various amounts of white, the value of the selected color should also be accounted for in creating harmonious relationships. While the most harmonious colors are at about the same value as the selected color, selecting harmonious colors within three values of the selected color provides acceptable harmonies. For example, as shown in FIG. 29, if the selected color has a value of 10, colors having values of 8 or 6 would create acceptable harmonies. Also according to the example shown in FIG. 29, if the selected color has a value of 6, colors of any value would create acceptable harmonies. While each color strip 28 in FIG. 29 has the same values, in reality, each color strip 28 can be presented with a different range of values than the neighboring color strip 28.

Color palettes so sorted can be applied to any color palette for fabrics, paints, inks, stains, dyes, or any other medium used to alter a color. The system and method can be used, for example: to coordinate the decoration of a room such that the colors of the walls harmonize with the furniture and other accessories; to coordinate the colors of clothing and fabrics; to match the exterior colors of a building; and anywhere where color coordination or selection is used.

### Sorting a Color Palette by Value

In Examples 1 through 3, the color palettes are sorted according to the saturation of each color. However, it is possible to sort the color palette by a color's value, if the saturation levels of all the colors in a palette at each value are about the same. As with the previous examples, first select an appropriate color identification standard representing the color spectrum comprising color groups from which color harmonies can be created. For purposes of illustration, refer to the color identification standards 10, 10b, and 10c that comprise a twelve-color group color schemes as shown in FIG. 1, 3 and 4. The colors in the color palette are sorted and/or labeled according to their value.

For each value, each color is then sorted and/or labeled into a color group to correspond to the order established by the selected color identification standard. Each color is further labeled and/or sorted within each color group into a gradient of colors based on the amount of color from one of the adjacent color groups that is present in that color. The colors are sorted and labeled according to their position in the color group and the number of colors in each color group is also noted and/or labeled onto each color as well.

Each of the color values can be labeled numerically, alphabetically, or by any other convention. The color groups within each value can be labeled according to the selected color identification standard being used, such as the color identification standards 10, 10a, 10b, or 10c shown in FIGS. 1 through 4, or they can be labeled numerically, alphabetically, or by any other convention. Within each of the color groups, the colors can be labeled numerically, alphabetically, or by any other convention that is consistent across all the color groups.

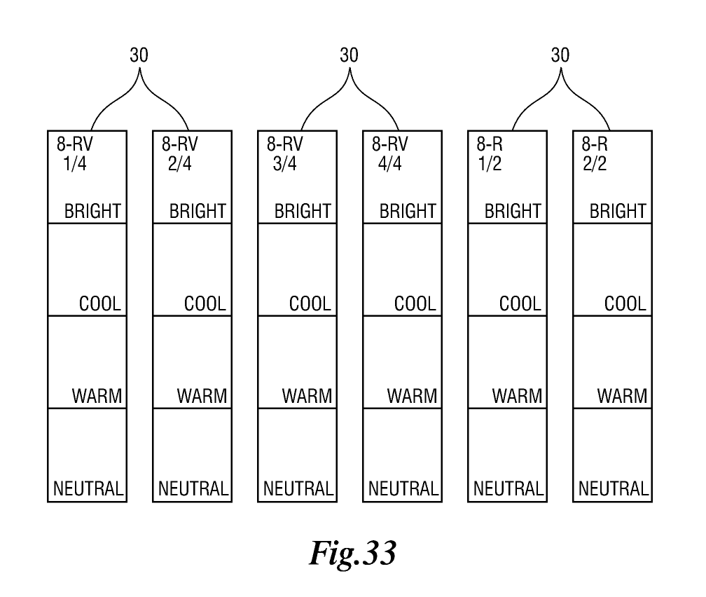

For example, FIG. 33 shows a variation of household paint color strips 30 in which each color strip 30 shows a color at a particular value. The same color is also presented at different saturation levels along each color strip 30, i.e. more or less saturated versions of the same color. In FIG. 33, four saturation levels are shown in descending order of saturation for each color strip 30. Each saturation level is labeled according to conventional saturation labels (Bright, Cool, Warm, Neutral). A color palette comprising a collection of such color strips 30 is compiled to show the range of available colors. Manufacturers often provide additional information on these color strips 30, such as the marketing name of the paint, the value of the color, etc. The example shown in FIG. 33, assumes a color palette having five value levels with each value level labeled in proportion to the value of each color: i.e., a value of 10 is the pure color; a value of 8 is a mixture comprising about 80% of the pure color and about 20% white, etc. FIG. 33 shows six colors of the example color palette having a value of 8 and applied to a color identification standard having twelve color groups as with the color identification standards 10, 10b, or 10c shown in FIGS. 1, 3, and 4: four colors in the red-violet color group and two colors in the red color group. The six colors are labeled as follows: 8-RV 1/4, 8-RV 2/4, 8-RV 3/4, and 8-RV 4/4 representing the red-violet color group of value 8; and 8-R 1/2 and 8-R 2/2 representing the red color group of value 8. The remainder of the color palette would be similarly labeled.

Identifying harmonious color combinations from a color palette so sorted would be similar to identifying harmonious color combinations for a color palette sorted by saturation level as described earlier. For example, assume a sorted and/or labeled color palette with five values, labeled 10, 8, 6, 4, and 2 for the lowest to the highest values (as a proportion of each color to white). The colors in the color palette are further sorted and/or labeled in accordance with the twelve color group color identification standards 10, 10b, or 10c shown in FIGS. 1, 3 and 4 with each color sorted and/or labeled numerically in each color group. Assume also that the color palette has at least one color in each color group at each saturation level. If a harmonious color combination is desired for a given color, say a low value red that is a bright saturated color, the color, or a color that's closest to it, must first be located within the sorted and/or labeled color palette.

The first step is to determine the value of the given color in relation to the color palette. If the given color appears to most closely match the lowest value colors in the color palette, then colors having a value of 10 (those having the highest proportion of the color compared to white) are selected and the remainder put aside.

The color group that the given color most resembles is then identified. If the red of the given color appears to have neither substantial red-orange nor substantial red-violet characteristics, it is likely that the closest color in the color palette is at or about the center of the color gradient of the R (red) color group. If the saturation level of each color is also presented (for example as with the color strips shown in FIG. 33), the color is matched to the saturation level.

### EXAMPLE 4

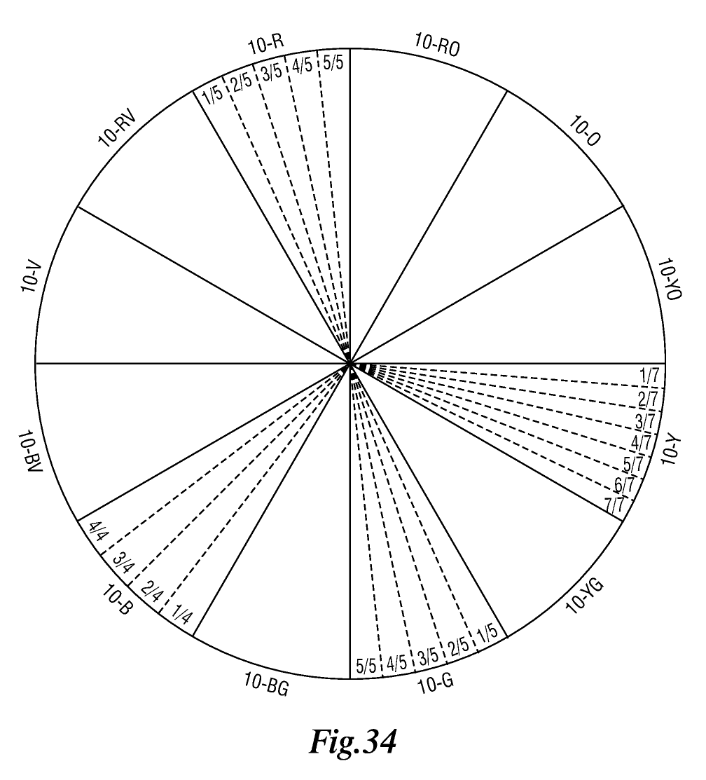

Referring now to FIGS. 34 through 36, if there were five colors in the R (red) color group at value 10, they would be labeled 10-R 1/5, 10-R 2/5, 10-R 3/5, 10-R 4/5, and 10-R 5/5. The closest color to the red color indicated above is the third of the five colors at the center of the 10-R color group. According to the example color palette, that color is labeled 10-R 3/5. With the color now identified, harmonious relationships can be developed based on known color harmonies. The complementary color to 10-R 3/5 is located at about the center of the color gradient green (G) color group at the same saturation level. If there are five colors in the value 10 green (G) color group, they would be labeled 10-G 1/5, 10-G 2/5, 10-G 3/5, 10-G 4/5, and 10-G 5/5. The complementary color to the 10-R 3/5 at the center of the value 10-G color group is 10-G 3/5.

Similarly, the harmonious color group representing the split complementary colors to 10-R 3/5 is at about the center of the gradient of colors in the B (blue) and Y (yellow) color groups at the value 10 level. If the B group has four colors, they are labeled 10-B 1/4, 10-B 2/4, 10-B 3/4, and 10-B 4/4. If the Y group has 7 colors, they are labeled 10-Y 1/7, 10-Y 2/7, 10-Y 3/7, 10-Y 4/7, 10-Y 5/7, 10-Y 6/7, and 10-Y 7/7. Because the B color group has an even number of colors, both 10-B 2/4 and 10-B 3/4 are at about the center of the color group. Therefore two split complementary harmonious relations are possible: 10-R 3/5, 10-B 2/4, and 10-Y 4/7 and 10-R 3/5, 10-B 3/4, and 10-Y 4/7. Other harmonious relationships are similarly identified by applying the same technique to the known color theory harmonies similar to the examples shown in FIGS. 5 through 28 or other known color harmonies.

### EXAMPLE 5

If the number of colors in the harmonious color group is not equal to the number of colors in the selected color group, then the best available harmonious color is one whose location in the harmonious color group most closely corresponds to the location of the selected color in it's color group. Therefore referring to Example 4, if there were eight colors in the value 10 G color group, they would be labeled 10 -G 1/8, 10-G 2/8, 10-G 3/8, 10-G 4/8, 10-G 5/8, 10-G 6/8, 10-G 7/8, and 10-G 8/8. The most harmonious color to 10-R 3/5 is located at about the center of the gradient of colors in the green color group. Given that there are eight colors in the G color group, the complementary colors are either 10-G 4/8 or 10-G 5/8.

### EXAMPLE 6

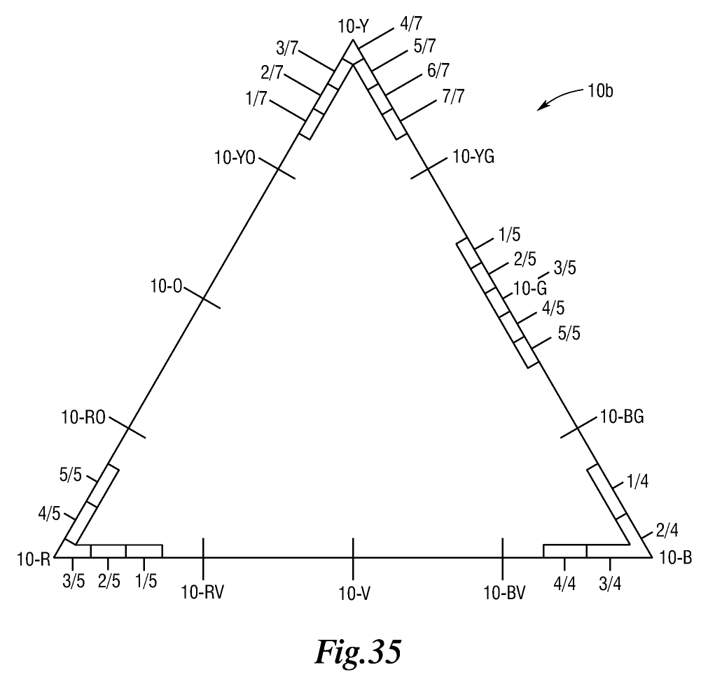

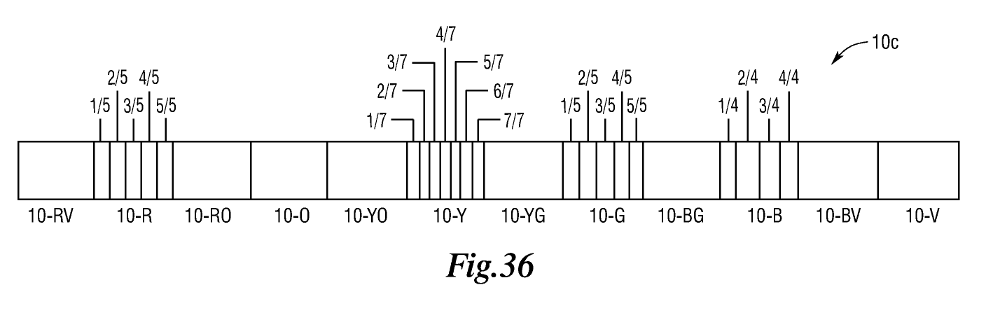

In example 4, if it were determined that a slightly different color in the 10-R color group was a better choice, new color harmonies are determined by applying the technique described above. Harmonious color combinations are located within their respective color groups based on the position of the new color within the 10-R color group. Referring again to FIGS. 34 and 35, if the selected color was changed to 10-R 2/5, one color choice in the counterclockwise direction in the selected color group, the most appropriate color harmonies will correspondingly change by one color choice in the counterclockwise direction in the harmonious color groups. Similarly, referring to FIG. 36, if the selected color was changed to 10-R 2/5, one color choice to the left in the selected color group, the most appropriate color harmonies will correspondingly change by one color choice to the left in the harmonious color groups. Thus, if there are five colors in the 10-G color group, the complementary color is now 10-G 2/5. If there are four colors in the 10-B color group and seven in the 10-Y color group then there are a few more options for the split complementary harmonies. Possible split complementary relations are: 10-R 2/5, 10-B 1/4, and 10-Y 3/7; 10-R 2/5, 10-B 2/4, and 10-Y 3/7; 10-R 2/5, 10-B 1/4, and 10-Y 2/7; and 10-R 2/5, 10-B 2/4, and 10-Y 2/7.

In all of the examples provided above, the palette of colors may not have the colors available to make perfectly harmonious color arrangements or the palette may have an uneven distribution of colors across color groups. In such cases, the sorting and labeling may not reflect the best harmonious groupings as a numerical sorting of the colors will not reflect where on a particular color identification standard a particular color is. In these cases, some manual verification must be made to harmonious groupings to ensure their accuracy.

While the most harmonious colors have the same value as the selected color, selecting harmonious colors within three values of the selected color provides acceptable harmonies. For example, for the selected color 10-R 3/5, colors having values of 8 or 6 would create acceptable harmonies; therefore 8-R 3/5 or 6-R 3/5 are also acceptable choices. Also, if the selected color has a value of 6, colors of any value would create acceptable harmonies.

Unlike selecting a different value, selecting a different saturation level for a chosen color would mean that any harmony combination developed might have to be reworked to match the new choice. Selecting colors across different saturation levels becomes a subjective choice that must be implemented by an experienced color professional to ensure proper color harmonies. An experienced color professional may make a judgment that the level of saturation of a strip makes it compatible with another because of the neutral quality of a color. If it were decided to maintain the saturation level of the selected color across all of the harmonious color combination, then the corresponding color combinations would have to be changed as well. For example, if the initial color choice was 8-BV 2/7 Cool and then a decision was made to select a warmer color, for example 8-BV 2/7 Warm, then any harmonious color combinations that had been identified for the original choice would have to be changed to a similar warmer saturation level.

### Identifying Harmonious Color Combinations

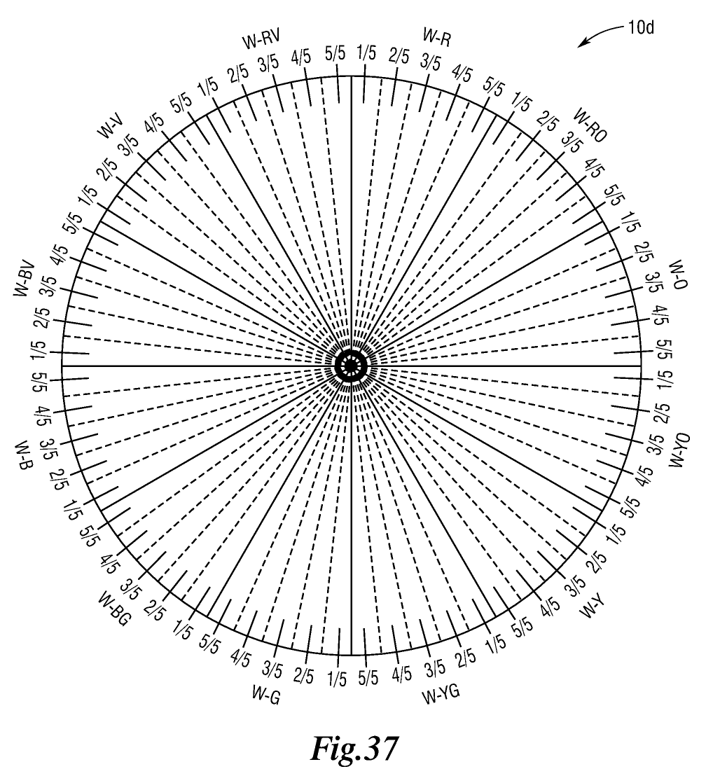

Given a color palette so sorted as above it is possible to identify a collection of colors from which harmonious color combinations can be made. In these collections saturation, value and hue are packaged so the harmonious color arrangement can be made quickly. For example, in a color palette having four saturation levels labeled B, C, W, and N (for Bright, Cool, Warm, and Neutral saturation levels, respectively), twelve color groups similar to the color identification standards 10, 10b, and 10c in FIGS. 1, 3, and 4, and five colors in each color group, the color palette would have a total of 240 colors. The 60 colors of the palette of colors at the W saturation level would be labeled as shown on the identification standard 10d in FIG. 37. In a color palette with equal numbers of colors in each color group, it is relatively easy to identify colors from which harmonious color combinations can be made. All of the colors labeled “1/5” can be grouped together and presented as a package with various known color harmonies made from those colors.

These groups will serve as a starting point from which decorators can make decisions on color choice in a simplified manner and with scientific accuracy rather than subjective choice in determining color harmonies. If the decorator prefers a color to the left or right on the progression of colors from what is presented, the color harmonies are easily determined by moving all the other colors in the package the same number of colors to the left or right. For example, if the collection presented the central color in each color group from the color identification standard 10d shown in FIG. 37, the collection would list the following colors: W-R 3/5, W-RO 3/5, W-O 3/5, W-YO 3/5, W-Y 3/5, W-YG 3/5, W-G 3/5, W-BG 3/5, W-B 3/5, W-BV 3/5, W-V 3/5, and W-RV 3/5. If the decorator preferred a red color with a little more violet in it, for example W-R 1/5 which is two colors to the left of W-R 3/5 in the progression of colors in the R color group, all of the other colors in the collection would have to move a similar number of colors to the left in order to maintain a collection from which harmonious color combinations can be made. Therefore the new collection would be: W-R 1/5, W-RO 1/5, W-O 1/5, W-YO 1/5, W-Y 1/5, W-YG 1/5, W-G 1/5, W-BG 1/5, W-B 1/5, W-BV 1/5, W-V 1/5, and W-RV 1/5. This would apply to any color identification system sorted according to the method presented herein. The same result would be obtained if the color identification standard were linear, triangular, or any other geometric shape, or if the color palette were sorted by value first and then by saturation.

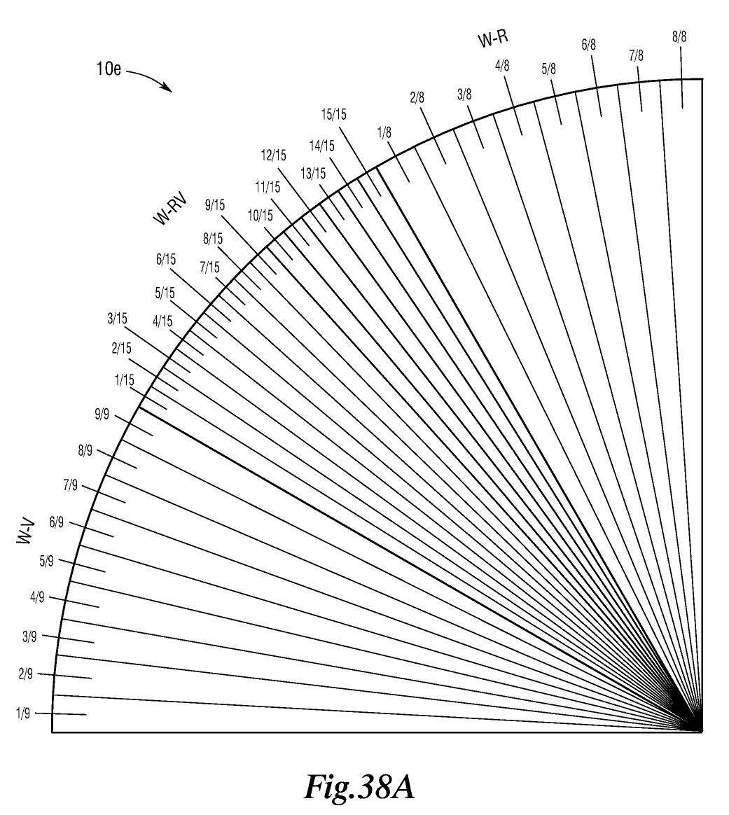

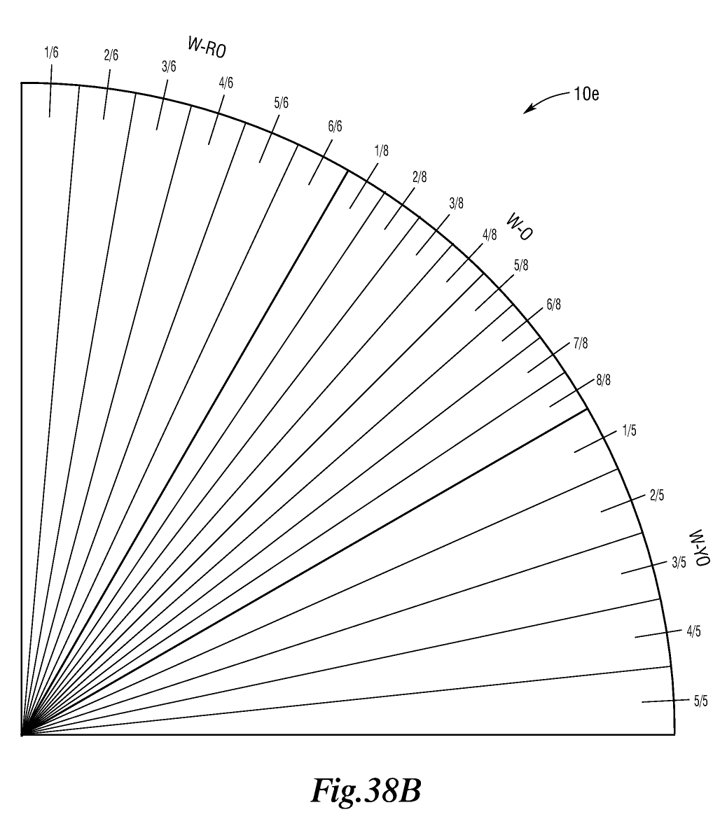

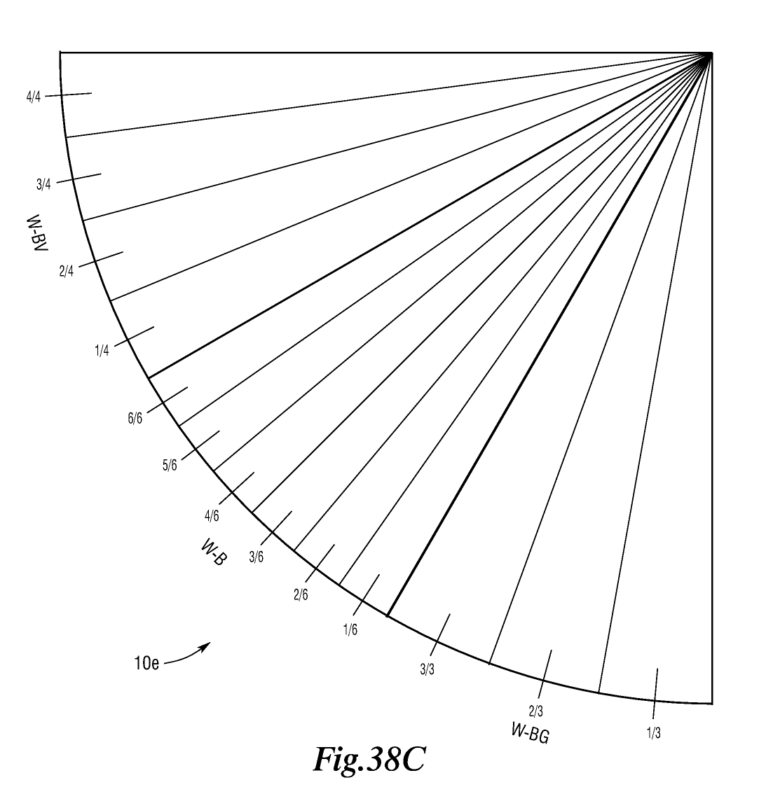

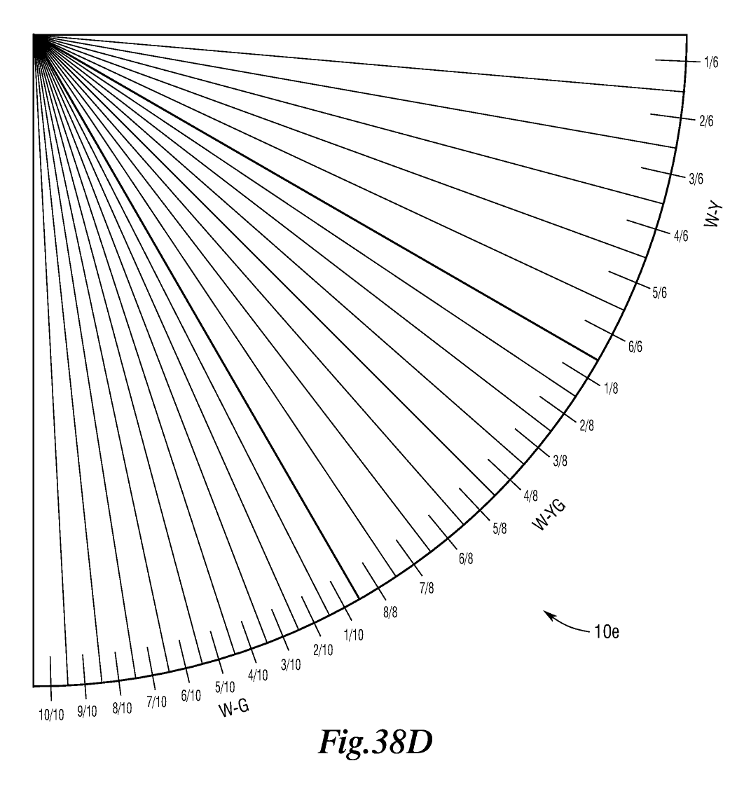

In color palettes in which there are an uneven number of colors in each color group, in some cases more than one color might suit fit a harmonious color combination. For example, if the collection presented the central color in each color group from the color identification standard 10e shown in FIGS. 38A-D, the collection would list the following colors: W-R 4/8, W-R 5/8, W-RO 3/6, W-RO 4/6, W-O 4/8, W-O 5/8, W-YO 3/5, W-Y 3/6, W-Y 4/6, W-YG 4/8, W-YG 5/8, W-G 5/10, W-G 6/10, W-BG 2/3, W-B 3/5, W-B 3/6, W-BV 2/4, W-BV 3/4, W-V 5/9, and W-RV 8/15. In this case several color groups have multiple choices from which harmonious color combinations can be selected. In color groups with more colors, selecting a slightly different color will not change the collection much, if at all. For example, if W-G 5/10 is the selected color, picking W-G 4/10 one color one to the left, will not effect the collection much. But if W-BG 2/3 is the selected color and W-BG 3/3 is chosen instead, the corresponding colors in the remaining color groups will have to be examined in more detail to determine harmonious color combinations. Nevertheless the basis concept remains the same and in order to develop harmonious color relationships, making different color choices requires adjustments being made to the available corresponding choices in the other color groups.

### Uses for Sorted Color Palettes

Given a palette of color sorted and/or labeled as described herein, it is possible to quickly identify collections of colors groups from which harmonious color arrangements can be made. For marketing purposes these collections could be produced to quickly determine harmonious combinations to popular colors as determined by season, personal taste, designer choice, etc. These collections could be pre-made and presented to customers to assist them in developing a color scheme for their projects and aid in their purchasing decisions. For purposes of customer education, basic designing principles could be provided to the customers, including the 60/30/10 rule in which the ratios of various colors in a project should be 60:30:10 for a scheme with three colors to achieve an impression of balance.

The system and method described herein can be adapted to a computerized color selection system. Given a palette of colors sorted and identified according to a color identification system as described above, the sorted and identified colors in the palette of colors may be stored in a computerized database. Such a computerized database can be utilized in many ways. The computerized database can include a listing of various types of possible harmonious color combinations. For each color and for each type of harmonious color combination, the computerized database can include identified appropriate harmonious color combinations in the palette of colors. Such a computerized database is useful if the color palette is not likely to change such that a fixed database of harmonious color combinations would not require updating every time a new color is introduced to the color palette.

A more dynamic computerized color selection system is possible in which the computerized color selection system on which the palette of colors is stored presents a listing of categories of various types of harmonious color combinations. For a selected color from the computerized database and a selected type of harmonious color combination, the computerized color selection system determines an appropriate harmonious color combination with the selected color from the colors available in the sorted color palette in the computerized database. The computerized color selection system does this by identifying the color group of the selected color, the color groups that are harmonious with the selected color based on the selected type of harmonious color combination, and identifying a color within each identified color group that is closest to the relative location in the identified color group that the first color is in its color group. Such a computerized color selection system is useful if the color palette is constantly being updated such that a fixed database of harmonious color combinations would require updating every time a new color is introduced to the color palette.

If the wavelengths of light for each paint color can be measured with a spectrograph, each color in the computerized database can be attributed with such information. The resulting database would have a record of every color available in the palette of colors, the sorted identifying information as set down as above, and the wavelength of each color.

Computerized databases as presented above would allow customers of color manufactures great flexibility in determining harmonious color groups and remove much of the mystery involving forming good color schemes. Several customer scenarios are possible. In all of these scenarios, a computerized color selection system is not necessary, but provides a more rapid method of performing and using the systems and methods described herein.

Scenario 1:

The customer has a color sample from a paint manufacturer that the customer prefers. In this case the computerized database will provide all possible color harmony combinations available for the chosen color. The customer may then pick and choose harmonies that suit his or her purpose. For each selected color harmony combination, the computerized color selection system can then prompt the user to select among a range of different values available for each color.

Scenario 2:

The customer has a color paint sample from an unknown source or from a different paint manufacturer. If the color wavelength of the sample can be measured with a spectrograph, the sample is compared to the wavelengths of color stored in the database. If an exact match is found, the computerized color selection system will identify the matched color in the database and present a listing of categories of various types of harmonious color combinations that can be made from the matched color. If needed, the customer may then pick and choose harmonies that suit his or her purpose. For each selected color harmony combination, the computerized color selection system can prompt the user to select among a range of different values available for each color.

If an exact match is not found, the database may provide the closest match to the sample or may provide a number of possible choices from which the customer may select his or her preference. For any selected color the computerized color selection system can present a listing of categories of various types of harmonious color combinations that can be made from the selected color. If needed, the customer may then pick and choose harmonies that suit his or her purpose. For each selected color harmony combination, the computerized color selection system can prompt the user to select among a range of different values available for each color.

If the customer has two color samples to match, by measuring the color wavelength of one of the samples the database will identify color harmonies to that color sample. The customer can then identify if the second color sample matches any of the possible color harmonies, either visually or by measuring the color wavelength of the second sample. The customer can develop a color scheme based on choices available. If the two colors in the sample are not in a harmonious color combination, the customer may choose one of the colors on which to base his or her color scheme.

Scenario 3:

The customer has a color sample from a piece of furniture or decoration to which he or she wishes to match the paint selection. The color sample wavelength of the sample is measured with a spectrograph and compared to the wavelengths of color stored in the database. If an exact match is found, the computerized color selection system will identify the matched color in the computerized database and will provide all possible color harmony combinations available for the matched color. The customer may then pick and choose harmonies that suit his or her purpose. If an exact match is not found, the computerized color selection system may provide the closest match to the sample or may provide a number of possible choices from which the customer may select their preference. For any selected color the computerized color selection system can provide all possible color harmony combinations available from which the customer may pick and choose to suit his or her purpose. For each selected color harmony combination, the computerized color selection system can prompt the user to select among a range of different values available for each color.

If the customer has two color samples to match or the color sample has more than one color in it, by measuring the color wavelength of one of the colors the database will identify color harmonies to that color. The customer may then identify if the second color matches any of the possible color harmonies, either visually or by measuring the color wavelength of the second sample. The customer can develop a color scheme based on choices available. If the two colors in the sample are not in a harmonious color combination, the customer may choose one of the colors on which to base their color scheme.

Scenario 4:

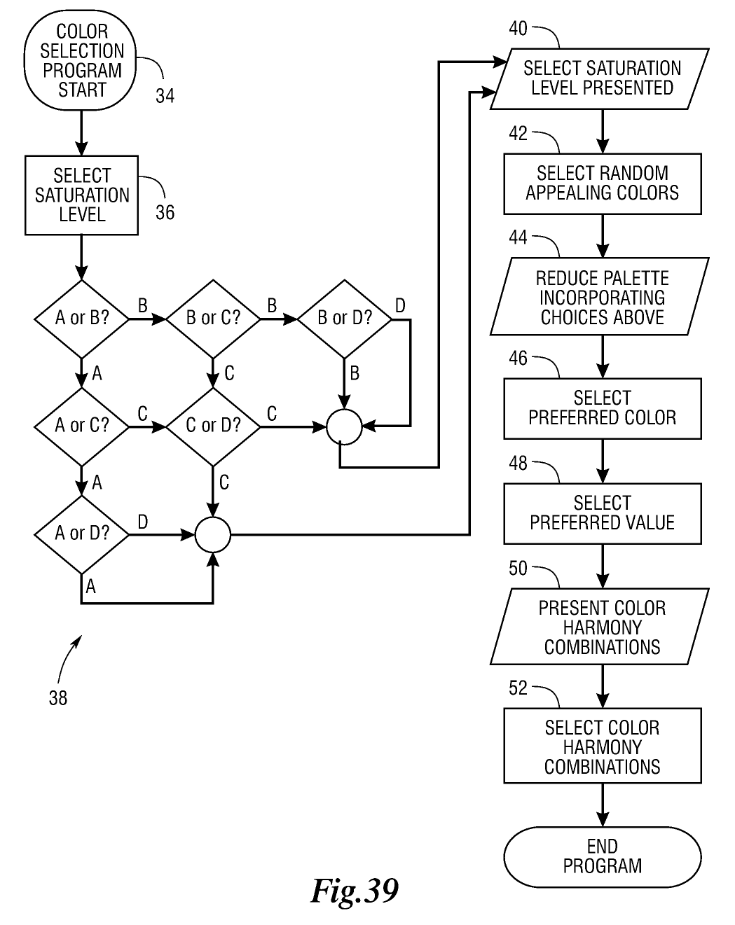

The color database can also be used for customers that have no idea what color to use and a color scheme has to be developed from scratch. This is not an uncommon occurrence given the sometimes-bewildering array of available color choices in many color palettes. In these cases, the customer is led through a process as outlined in the flow diagram 32 in FIG. 39, in which a harmonious color scheme is developed for the customer with the customer making all the choices. The customer is presented with the computerized color selection system program 34 that will guide him or her through the process of determining a color scheme from the multitude of color choices available in the color palette stored in the computerized database.

The customer first reduces the list of colors to a more manageable level by selecting a preferred color saturation level 36. The customer is presented with a representative range of colors at two saturation levels and asked to make a preference selection. In order to not influence the customer's choice, it is preferable that the saturation levels are presented without providing any verbal descriptors of the saturation level. If the color palette has more than two saturation levels, for example if the color palette comprises four saturation levels (bright, cool, warm, and neutral), the choice of saturation levels can be presented with some non-identifiable title such as the letters of the alphabet (A, B, C, D, etc.) or numbers (1, 2, 3, 4, etc.). In the present example, assume the color palette stored on the computerized database comprises four saturation levels that are labeled A, B, C, and D corresponding to bright, cool, warm, and neutral saturation levels, respectively.

The customer is presented with choices 38 of ranges of colors at pairs of saturation levels until all but one saturation level is eliminated and presented to the customer for approval 40. Alternatively, the customer can be presented with ranges of colors at all the available saturation levels and the customer then makes his or her preferred saturation level selection. As another option if the customer cannot decide based on the choices presented, he or she can be asked to select a number of colors that appeal to them and the saturation level with the most selected colors would be presented as the customer's choice. No matter how a saturation level selection is made, at that point the customer has eliminated 75% of the color choices in color palettes having four saturation levels. For marketing purposes, this fact can be presented to the customer as a psychological victory after being faced with an apparent endless array of color choices available.

The customer then has to select a preferred color. To further narrow this choice down to a more manageable level, the customer is asked to select 42 a number of appealing colors randomly from the color palette at the selected saturation, again preferably without being presented with any identifying names or titles. The computerized color selection system identifies the choices and based on where the choices lie in the progression of colors in each color group. A reduced palette 44 incorporating as many of the selected colors as possible is provided to the customer. For example: assume the color identification standard used in the computerized color selection system has the twelve color groups as shown above for the color identification standards 10, 10b, or 10c in FIGS. 1, 3, and 4. The customer selects 42 five colors at random from the presented color palette, and the color selection program identifies the choices, for example, as YG 4/8, RO 8/16, BG 2/3, BV 7/7, and Y 1/6. The computerized color selection system identifies that a majority of the selected colors (YG, RO, and BG) are in the middle of their respective color groups. The color selection program will then present a reduced palette 44 to the customer that will include at least one color from each color group from about the middle of each color group.

From the reduced palette 44, the customer then selects a preferred color 46. The computerized color selection system then prompts the customer to select a value for the preferred color 48. The computerized color selection system then provides a summary of known harmonious color combinations to the selected color 50. The customer then selects a preferred harmonious color combination 52 identified by the computerized color selection system. The computerized color selection system can then provide a printout out of the selected colors for the customer to purchase.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

What is claimed is:

1. A method for sorting and selecting colors from a palette of colors comprising:
selecting a color identification standard representing the color spectrum comprising color groups from which color harmonies can be created;
sorting the palette of colors by a first attribute of the color;
for each first attribute level, further sorting each color of the palette of colors to correspond to the color groups in the selected color identification standard;
further sorting each color of the palette of colors in each color group into a gradient of colors based on the amount of color from adjacent color groups present in each color and the number of colors in the color group in which each color is located, such that, for each color, corresponding available harmonious colors are generally sorted to about the same relative location within their respective color groups; and
further sorting each color of palette of colors by a second attribute of the color.

2. The method of claim 1 in which the first attribute of the color is saturation and the second attribute of the color is value.

3. The method of claim 1 in which the first attribute of the color is value and the second attribute of the color is saturation.

4. The method of claim 1 in which the palette of colors is for any of the group consisting of fabrics, paints, inks, stains, and dyes.

5. The method of claim 1 in which the color identification standard is from the group consisting a circle, a triangle, a line, a rectangle, and a square.

6. The method of claim 1 further comprising:
selecting a first color from the sorted palette of colors;
identifying the color group of the first color;
selecting a desired type of harmonious color combination with respect to the first color;
identifying color groups that are harmonious with the first color based on the selected type of harmonious color combination; and
selecting a color within each identified color group at about the same relative location in the identified color group that the first color is in its color group to create an appropriate harmonious color combination with the first color.

7. A color selection system for selecting harmonious colors to selected colors within a palette of colors comprising:
the palette of colors sorted by a first attribute of the color; each color further sorted to correspond to a color group according to a selected color identification standard representing the color spectrum, the color identification standard comprising color groups from which color harmonies can be created; each color further sorted in each color group into a gradient of colors based on the amount of color from adjacent color groups present in each color and the number of colors in the color group in which each color is located, such that, for each color, corresponding available harmonious colors are generally sorted to about the same relative location within their respective color groups; and each color further sorted by a second attribute of the color.

8. The color selection system of claim 7 in which the first attribute of the color is saturation and the second attribute of the color is value.

9. The color selection system of claim 7 in which the first attribute of the color is value and the second attribute of the color is saturation.

10. The color selection system of claim 7 in which the palette of colors is for any of the group consisting of fabrics, paints, inks, stains, and dyes.

11. The color selection system of claim 7 in which the color identification standard is from the group consisting a circle, a triangle, a line, a rectangle, and a square.

12. The color selection system of claim 7 in which for a selected first color from the sorted palette of colors and a desired type of harmonious color combination with respect to the first color, the color selection system enables identification of the color group of the first color, identification of color groups that are harmonious with the first color based on the desired type of harmonious color combination, and selection of a color within each identified color group at about the same relative location in the identified color group that the first color is in its color group to create an appropriate harmonious color combination with the first color.

13. A computerized color selection system for a palette of colors comprising:
a computerized database which includes the palette of colors sorted and identified by a first attribute of the color, each color further sorted and identified to correspond to a color group according to a selected color identification standard representing the color spectrum, the color identification standard comprising color groups from which color harmonies can be created, each color further sorted and identified in each color group into a gradient of colors based on the amount of color from adjacent color groups present in each color and the number of colors in the color group in which each color is located, such that, for each color, corresponding available harmonious colors are generally sorted to about the same relative location within their respective color groups, and each color further sorted and identified by a second attribute of the color;

14. The computerized color selection system of claim 13 further comprising:
said computerized database including categories of various types of harmonious color combinations;
for each color and for each type of harmonious color combination, said computerized database including identified appropriate harmonious color combinations in the palette of colors.

15. The computerized color selection system of claim 13 further comprising listings of categories of various types of harmonious color combinations, such that for a selected first color from said computerized database and a selected type of harmonious color combination, the computerized color selection system identifies the color group of the first color, the color groups that are harmonious with the first color based on the selected type of harmonious color combination, and identifies a color within each identified color group that is closest to the relative location in the identified color group that the first color is in its color group to create an appropriate harmonious color combination with the first color.

16. The computerized color selection system of claim 13 in which said computerized database further includes wavelength information for each color in the palette of colors.

17. The computerized color selection system of claim 13 further comprising
said computerized database further includes wavelength information for each color in the palette of colors; and
a spectrograph, such that the wavelength of a sample of color outside of the palette of colors can be measured and matched to the color having the closest similar wavelength in the palette of colors.

18. The computerized color selection system of claim 13 in which the first attribute of the color is saturation and the second attribute of the color is value.

19. The computerized color selection system of claim 13 in which the first attribute of the color is value and the second attribute of the color is saturation.

20. The computerized color selection system of claim 13 in which the palette of colors is for any of the group consisting of fabrics, paints, inks, stains, and dyes.

21. The computerized color selection system of claim 13 in which the color identification standard is from the group consisting a circle, a triangle, a line, a rectangle, and a square.
